(19) United States
(12) Patent Application Publication
(10) Pub. No.: US 2007/0186461 A1
(43) Pub. Date: Aug. 16, 2007

(54) Fishing Lure That Releases a Color Cloud

(76) Inventor: Stanley Sarnacki, Shrub Oak, NY (US)

Correspondence Address: ADVANTIA LAW GROUP, 9035 SOUTH 1300 EAST, SUITE 200, SANDY, UT, 84094, US

(21) Appl. No.: 11/307,652

(22) Filed: Feb. 15, 2006

(51) Int. Cl. A01K 85/00; A01K 85/01

(52) U.S. Cl. 43/42.32; 43/42.06

(57) ABSTRACT

A fishing lure color cloud strip that appeals to the visual sensory system of fish. Specifically, there is a fishing lure that includes the fishing lure color cloud strip that may be combined with a fish scent emitter. In one embodiment of the invention, there is an adhesive tape comprising a material that releases a fish attracting colorized fog that is applied thereto for use with a fishing article selected from the group consisting of lures, spinners, spoons, hooks and sinkers, the tape having of thickness of 13 mil or less. The tape may be designed to have the colorant sealed into the tape by application of a water soluble sealant material over the colorant, the sealant material dissolving on introducing the tape into water thereby allowing for release of the colorant thus creating a fog of color. In another embodiment, the tape may further comprise an adhesive layer, an absorbent layer and a release coated flexible substrate, the adhesive layer to be applied to a lure, the absorbent layer impregnated with the fish attractant color fog emitting material and the release coated flexible substrate serving to seal in the fish attractant color fog prior to use.

### BACKGROUND OF THE INVENTION

1. Field of the Invention

The present invention relates generally to relates to a fishing lure that releases a color cloud that appeals to the visual sensory system of fish. Specifically, there is a fishing lure that includes the fishing lure and color cloud release material that visually attracts fish with or without being combined with a fish scent attractant.

2. Description of the Related Art

Over the years, the field of fishing has advanced from the use of live bait to the use of artificial lures. Recently, a great deal of attention has been focused on the development of fish attractants.

A recent In-Fisherman subscriber survey conducted by Added Value Inc. revealed that 70% of respondents used scent enhanced baits or attractants in the 12 months prior to the survey. Moreover, scent enhanced baits were used by 79% of those who fish for bass most often. Among the brands used most often by respondents were Berkeley™, Fish Formula™, Dr. Juice™ and Ultimate Baitmate™.

To date, a number of different types of scented lures have been disclosed. The following patents are incorporated by reference for their supportive teachings and for illustrating features of the prior art: There are lures formed from fish food which provides a scent to attract fish such as U.S. Pat. No. 5,063,703 to Riley. There are lures formed of materials that have been intermixed with scents such as U.S. Pat. No. 4,953,319 to Kasper et. al. that discloses a lure with a fish oil intermixed with the plastic formulation from which the lure made, and U.S. Pat. No. 4,875,305 to Bridges that discloses a slowly dissolving lure made of a polymer with a fish scent attractant impregnated therein. There are also lures having inner receptacles containing scented substances or fluids such as U.S. Pat. No. 5,170,579 to Hollinger describing a lure comprising a pouch for receiving bait or scented substances. U.S. Pat. No. 5,321,906, to Bommarito, describes a fishing scent delivery system comprising a bladder which releases a fishing scent material in the vicinity of a fishing lure. Whereas, U.S. Pat. No. 5,517,781 to Paoletta, Jr. discloses a lure having a reservoir from which a scented fluid is dispensed. Other types of scent bearing lures include those in which scent impregnated materials not integral to the lure structure is included such as U.S. Pat. No. 4,962,609 to Walker that discloses a lure comprising an absorbent fibrous material impregnated with fish attractant. U.S. Pat. No. 5,018,297 to Kennedy, Jr. discloses a fishing lure with a cellular, porous scent receiving material inserted into a cylinder within the lure. U.S. Pat. No. 5,142,811 to Freeman discloses a fishing lure having a fish attractant dispenser such as a scented pipe cleaner inserted into an inner casing.

What is needed is a fishing lure that uses an attractant that is not scent related, and has the effect of visually attracting fish to the fishing lure by means other than items that are attached to the lure itself. There is a need for a fishing lure that attracts fish that emits a cloud of color that trails behind the fishing lure to lead the fish to the lure. Thus, there is a need for a lure that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available fishing lure devices. Accordingly, the present invention has been developed to provide a fishing lure that releases a color cloud into the water that appeals to the visual sensory system of fish. Specifically, there is a fishing lure that includes the fishing lure color cloud strip that may be combined with a fish scent emitter.

In one embodiment of the invention, there is an adhesive tape comprising a material that releases a fish attracting colorized fog is applied thereto for use with a fishing article selected from the group consisting of lures, spinners, spoons, hooks and sinkers, the tape having of thickness of 13 mil or less.

In another embodiment of the invention there may be a tape that may be removable.

In another embodiment of the invention there may be a tape that may be a polyurethane based open cell foam with adhesive backing.

In another embodiment of the invention there may be a tape that may be designed to have the colorant sealed into the tape by application of a water soluble sealant material over the colorant, the sealant material dissolving on introducing the tape into water thereby allowing for release of the colorant thus creating a fog of color.

In another embodiment of the invention there may be a tape that may further comprise an adhesive layer, an absorbent layer and a release coated flexible substrate, the adhesive layer to be applied to a lure, the absorbent layer impregnated with the fish attractant color fog emitting material and the release coated flexible substrate serving to seal in the fish attractant color fog prior to use.

In another embodiment of the invention there may be a tape that may be that the colorant is sealed into the tape by application of a water soluble sealant material over the colorant, the sealant material dissolving on introducing the tape into water thereby allowing for release of the colorant.

In another embodiment of the invention there may be a tape that may be an adhesive tape that further comprises an adhesive layer, an absorbent layer and a release coated flexible substrate, the adhesive layer to be applied to a lure, the absorbent layer impregnated with the fish attractant colorant and the release coated flexible substrate serving to seal in the fish attracting colorant prior to use.

In another embodiment of the invention there may be a tape that may be designed so the colorant is released over ½ hour or more.

In another embodiment of the invention there may be a tape that may be designed so the tape is colored to resemble a fish.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a schematic side view of one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

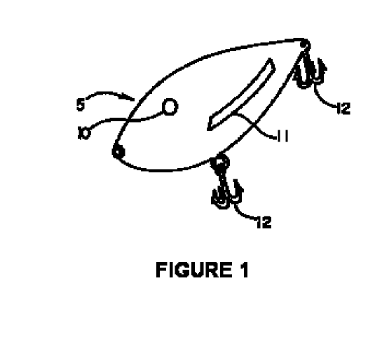

FIG. 1 illustrates a schematic side view of one embodiment of the invention. Specifically, there is illustrated one embodiment with a fishing lure color cloud strip that includes a waterproof substrate preferably a waterproof tape to which a color cloud producing substance may be applied. Preferably, the tape will hold the color cloud dispersal material that has the ability to last for at least ½ hour or longer. Suitable waterproof tapes useful in the practice of the present invention include absorbent cloth based tapes and absorbent polymer based tapes, for example, 13 mil or less polyurethane open cell foam tapes with adhesive backings, such as Medifix™, manufactured by Medifix™ Adhesive Products, Limited, Bedfordshire, England, although any other waterproof tape, especially absorbent tape may be used as well.

It is also important that the tape be very thin and/or lightweight so as not to substantially affect the balance of the lure to which the tape is attached. Preferably, the tape will have minimal effect on the balance and/or hydrodynamics of the lure. The tape should be formed of a material which may be easily shaped and cut to enable the manufacture of different shapes and sizes such as dots, strips and any other suitable shapes. The tape may also be formed as a sheet of kiss-cut. The kiss-cut sheet consists of adhesive tape pre-cut into one or more desired shapes on a substrate. The pre-cut shapes may be peeled off the substrate. Also, the tape must be able to adhere to plastics and metals such as those from which fish lures are built.

In the practice of the invention, the fish attracting color cloud material is applied to the tape so that the colorant material is absorbed or otherwise impregnated into the tape. The colorant material may be applied to the tape by spraying the tape with the material, painting the material onto the tape, pressing the material into the tape, soaking the material into the tape or any other suitable means. In particular, the material having the fish attracting color cloud may be embedded in a slow release polymer applied to the tape so that the scented material is released over a desired period of time. The thus formed fishing lure color cloud strip is then applied to a fishing lure as shown in FIG. 1.

In FIG. 1, there is one general embodiment of the invention. Specifically, the fish lure 5 includes two color cloud strips 10 and 11. There is a dot shaped fishing lure color cloud strip 10 placed thereon to simulate an eye of a fish. Additionally, in this embodiment, the lure 5 further has an additional color cloud strip 11 placed thereon to simulate the lateral line of a fish. As is typical, there are hooks 12 attached to the lure 5.

FIG. 1 is meant to be illustrative only. It will be recognized that other patterns of fishing lure color cloud strip may be applied to the lure as well. The dots and stripes may be fluorescent, brightly colored, metallic colored, for example, to resemble shiny aluminum or metallic flakes or otherwise colored so as to simulate a fish or attract a fish.

The inventive fishing lure color cloud strip may be shaped to fit on a hook, a sinker, a spinner or a spoon. In use, the fishing lure color cloud strip may be wrapped around the hook or sinker or placed on the concave backside of a spinner or spoon.

In another embodiment, the present invention is directed to a method of preparing a color cloud emitting fishing lure from a fish lure. This may be done by applying the fishing lure color cloud strip to the fishing lure. The colorant cloud strip may be in the form of a waterproof tape that is impregnated with a colorant material that will be emitted into the water as the lure is pulled through the water for attracting fish to the body of the lure.

In yet another embodiment, the present invention is directed to a method for retrofitting a used fish lure by applying to the lure an inventive fishing lure color cloud strip.

In yet another embodiment, the present invention is directed to a fishing lure color cloud strip including a waterproof tape impregnated with an additional material having a fish attracting scent for use with a fish lure. Such a fishing lure color cloud strip may be provided in bulk or as individual strips or dots to be applied to a lure, hook, sinker, spinner or spoon. Such a strip may also be provided as cut outs on kiss-cut (adhesive tape pre-cut into one or more desired shapes on a substrate). The fishing lure color cloud strip may be suitably colored or fluorescent so as to better simulate a fish or provide further attraction to the fish.

In yet another embodiment, the invention is directed to a lure enhancement kit adapted for use with a fish lure, the kit comprising an absorbent waterproof tape and one or more fish attracting color materials to be released into the water. Optionally, the kit may be comprised of several pieces of tape, each piece already impregnated with a certain color material. In this manner, the fisherman may choose from a wide array of fishing lure color cloud strips to emit different color clouds into the water. The color selection would be dependent upon the particular fish being sought and ambient conditions. The kit may also contain a variety of shapes of tape ranging from different size strips to different diameter dots of tape. The tape may be provided in various shapes and sizes in kiss-cut form. Optionally, the kit may further contain a fish lure, hook, sinker, spoon or spinner.

The invention also provides a method for retrofitting a used fish lure by applying a molded jacket entirely, or nearly so, over a substantial portion of the used fish lure. The jacket may be formed of any suitable material such as plastic and is patterned after a lure. The jacket further comprises waterproof tape impregnated with a material having a scent for attracting fish thereto and contoured to the body of the lure. Holes are provided in the jacket for any hooks or other protuberances emerging from the lure. The jacket may be secured to itself to provide a worn lure with a new pattern. The jacket may be colored so as to resemble a fish, or otherwise attract a fish thereto. The use of fluorescent materials is also contemplated to attract the fish to the lure as are the use of metallic looking materials including materials which resemble shiny aluminum, or which resemble metallic flakes.

The inventive fishing lure color cloud strips may be stored under vacuum or under an inert gas until use or may further have the color sealed therein by application of a water soluble sealant material over the colorant. The sealant material dissolves on introducing the tape into water thereby allowing for release of the color cloud in the water. The colorant may also be sealed in the adhesive tape via the use of an additional removable layer of a substrate resting above the colorant containing material. In such an embodiment, the fishing lure color cloud strip may include an adhesive layer, an absorbent layer and a release layer. The absorbent layer would be resting atop the adhesive layer would be impregnated with a fish color attractant slow release cloud material and the release layer is placed thereon to seal in the fish attractant colorant prior to use.

In use, the release layer would be peeled off of absorbent layer after the fishing lure color cloud strip has been applied to the lure and the lure placed on the fishing line. In this manner, not only is diffusion of the colorant from the tape minimized but additionally, contamination of the lure with human scents is minimized. While any suitable release material may be used for the release layer, it is preferable to use substrates including oriented polypropylene (OPP) films, siliconised OPP and polyester, silicon coated paper. Release layers having a slight tack may be used as well.

The fishing lure color cloud strips of the present application may also have an optional release coated layer adjacent to the waterproof adhesive. In one preferred embodiment, the tape may be generally a 13 mil or less polyurethane open cell foam tape with adhesive backing (such as Medifix™. The tape may have a release coated layer adjacent to adhesive layer. The release coated layer may be removed from the adhesive layer prior to applying tape to a lure. The fish attractant colorant may be applied to the tape surface to form the inventive fishing lure color cloud strip.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Although specific depiction of certain elements is provided in the accompanied drawings, it is to be understood that the drawings are merely illustrated. For example, the fact that the description of the invention uses the word “strip” does not mean that the color cloud impregnated material needs to be in the form of a strip of material. In fact, a skilled artisan will realize that most any shape of material will work, for example, a dot, a semi-circle, a wavy line, a fish, a cat picture, among others may all be used.

Additionally, there is illustrated a certain type of fishing lure. Wherein, a skilled artisan will easily realize that most any type of fishing lure will suffice.

It is noted that any type of material that will emit a fog of color into the water as the fishing lure is pulled there through. For example, an oil based material may be used that has a basic color characteristic that is viewable under water may be used. Similarly, a powderous material may be impregnated into the tape that is slowly released into the water as a cloud like emission. Also, an encapsulated material may work where each capsule will dissolve into the water at a different rate of time. Thus, some capsules will release its colorant into the water sooner than others.

It is further noted that food coloring may be a suitable material to create a colorized fog in the water. Any material used in paint may be used. Most preferably, the colorant will be biodegradable over time.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. An adhesive tape comprising a colorant material that releases a fish attracting, bio-degradable, colorized fog that is applied thereto for use with a fishing article selected from the group consisting of lures, spinners, spoons, hooks and sinkers, the tape having of thickness of 13 mil or less.

2. The adhesive tape of claim 1, wherein the tape is removable.

3. The adhesive tape of claim 1, wherein the tape is a polyurethane based open cell foam with adhesive backing.

4. The adhesive tape of claim 1, wherein the colorant material is sealed into the tape by application of a water soluble sealant material over the colorant material, the sealant material dissolving on introducing the tape into water thereby allowing for release of the colorant material.

5. The adhesive tape of claim 1, further comprising an adhesive layer, an absorbent layer and a release coated flexible substrate, the adhesive layer to be applied to a lure, the absorbent layer impregnated with the fish colorant material and the release coated flexible substrate serving to seal in the fish colorant material prior to use.

6. (Canceled)

7. (Canceled)

8. The adhesive tape of claim 1, wherein the colorant material is released over ½ hour or more.

9. The adhesive tape of claim 8 wherein the tape is colored to resemble a fish.

10. An improved colorant material fog release fish lure comprising a fishing article selected from the group consisting of lures, spinner, spoons, sinkers and hooks with a first adhesive tape of thickness 13 mil or less having a first color fog producing substance for attracting fish applied thereto, the tape adhered to the fishing article.

11. The colorant material release fishing lure of claim 10, wherein the colorant material is sealed into the tape by application of a water soluble sealant material over the colorant material, the sealant material dissolving on introducing the tape into water thereby allowing for release of the colorant material.

12. The colorant material release fishing lure of claim 10 wherein the tape is formed of a release coated flexible substrate, the adhesive layer to be applied to a lure, the absorbent layer impregnated with the colorant material and the release coated flexible substrate serving to seal in the colorant material prior to use.

13. The colorant material release fishing lure of claim 10 wherein the tape is applied to the lure so as to resemble the marking of a fish.

14. The colorant material release fishing lure of claim 10 wherein the appearance of the tape is selected from the group consisting of fluorescent appearances, colored appearances, and metallic appearances.

15. The colorant material release fishing lure of claim 10 wherein the tape is dot-shaped.

16. The colorant material release fishing lure of claim 15 wherein the tape is applied to the lure so as to resemble fish eyes.

17. The colorant material release fishing lure of claim 10 wherein the tape is a polymer based waterproof tape.

18. The colorant material release fishing lure of claim 17 wherein the tape is a polyurethane based open cell foam with adhesive backing.

19. The colorant material release fishing lure of claim 10 wherein the tape is a cloth based waterproof adhesive tape.

20. A method of modifying a fishing lure to attract fish thereto, comprising the steps of:
providing a fishing lure; and
providing a selection of at least two color impregnated materials, wherein the first color impregnated material will emit a first color of material into the water and the second color impregnated material will emit a second color of material into the water when pulling the fishing lure through the water;
wherein the first color and the second color are different.

21. The adhesive tape of claim 1, wherein the colorant material comprises a powder.

22. The improved colorant material fog release fish lure of claim 10, further comprising a second adhesive tape of thickness 13 mil or less having a second color fog producing substance for attracting fish applied thereto, the tape adhered to the fishing article, and wherein the first color and the second color produce different colors.
